(19) United States
(12) Patent Application Publication
(10) Pub. No.: US 2012/0143935 A1
(43) Pub. Date: Jun. 7, 2012

(54) FILTER DEVICE AND METHOD FOR PROVIDING A FILTER DEVICE

(75) Inventors: Changsong Xie, Munich (DE); Fabian Nikolaus Hauske, Munich (DE)

(73) Assignee: Huawei Technologies Co., Ltd., Shenzhen (CN)

(21) Appl. No.: 13/339,746

(22) Filed: Dec. 29, 2011

Related U.S. Application Data
(63) Continuation of application No. PCT/CN2010/070695, filed on Feb. 20, 2010.

(51) Int. Cl. G06F 17/10

(52) U.S. Cl. 708/301

(57) ABSTRACT

The invention relates to a filter device (200) for filtering an input signal (s(t)). The filter device (200) has a plurality of taps (210-216) having a respective filter coefficient (w₀-w₆) and a plurality of delay elements (221-226), wherein at least two delay elements (221-226) have different delays.

### CROSS-REFERENCE TO RELATED APPLICATIONS

This application claims the benefit of International Application No. PCT/CN2010/070695, filed on Feb. 20, 2010, entitled “Filter device and method for providing a filter device”, which is hereby incorporated by reference.

### BACKGROUND

The present invention relates to filter devices, like Finite Impulse Response (FIR) filters, in particular in optical communication systems.

An FIR filter conventionally has a constant time delay or delay between its adjacent taps. In this regard, FIG. 1 shows an FIR filter 100 which is configured to filter an input signal s(t) for providing a filtered output signal r(t). The FIR filter 100 has a plurality of taps 110-116 with a respective filter coefficient w₀-w₆. Further, the FIR filter 100 has a plurality of delay elements 121-126, wherein the delay elements 121-126 have a respective constant delay T. The outputs of the taps 110-116 are added by an adder entity 130 for providing the filtered output signal r(t).

The sum of all time delays T defines the impulse response time of the FIR filter 100. For equalization, the filter impulse response time should be larger or equal to the channel memory time. Otherwise, channel impairments may not be fully compensated.

Such a conventional FIR filter, also called transversal filter, employs said equally spaced time delays or delays T between the adjacent taps such that the filtered output results in

r(t)=w_{M}s(t−MT)+w_{M-1}s(t−(M−1)T)+ . . . +w₁s(t−T)+w₀s(t)

with the filtered signal r(t) the input signal s(t), filter coefficients or tap weights wᵢ,iε{0,1, . . . , M} and a tap delay T. Typically, the delay T, also called tap delay T, refers to the symbol duration T_{S}. In optical communication systems, a tap delay of T=T_{S}/2 is employed, which refers to two-fold over-sampling relative to the Baudrate. The benefit of over-sampling with a finer resolution of the tap spacing is demonstrated for optical transmission systems by T. Duthel, et al. “Impairment tolerance of 111 Gbit/s POLMUX-RZ-DQPSK using a reduced complexity coherent receiver with a T-spaced equalizer”, European Conference on Optical Communication, Berlin, Germany, paper Mo.1.3.2, Sep. 16-20, 2007.

For reducing implementation complexity, the total number of taps should be as low as possible, e.g. a total number of nine taps, which may refer to an impulse response duration of the FIR filter of 4 T. There might be channel conditions where the channel memory exceeds the impulse response time of the FIR filter, e.g. by large differential group delay (DGD). For covering such cases, the filter impulse response time has to be increased.

In this regard, a basis for the above may be found in Simon Haykin, “Adaptive Filter Theory”, 4^{th} edition, Prentice Hall, 2002, Chapter “Background and preview”, Section 4: Linear Filter Structures, and in Nevio Benvenuto and Giovanni Cherubini, “Algorithms for Communications Systems and their Applications”, Wiley, 2002, Chapters 1.3-1.4.

Moreover, given a constant number of taps, either a spacing of 2 T=Tₛ is applied which has an extended filter impulse response, but which suffers a principal filtering penalty in optical systems as mentioned above. Here, document U.S. Pat. No. 5,838,740 A describes T=Tₛ/2 spaced FIR taps that only cover half of the filter impulse duration.

### SUMMARY

A goal to be achieved by the present invention is to provide a trade off between a long filter impulse duration and a high resolution. This may be achieved by a hybrid filter structure of the present invention with different delays. Thus, according to some implementations, various delays or tap delays may be incorporated in one filter design. The delay structure may be made adaptive, by including or excluding delay elements between two adjacent taps, in order to adjust the structure to the channel memory or it may be static designed to meet a certain requirement.

The channel memory may cause signal impulses to spread over several symbol slots such that they may interfere with the adjacent pulses. Particularly, the edges of a pulse may only contain little pulse energy compared to the pulse center. Thus, the information about the pulse close to its edge is low compared to the pulse center. The FIR filter in an equalizer may try to supply the inverse channel impulse response such that the pulse spreading of the channel is reversed and an undistorted pulse may be obtained after equalization. A short delay between the FIR filter taps, which refers to a high sampling rate, may provide a better resolution with an enhanced presentation of the inverse channel impulse response than a long delay, Therefore, a larger total number of taps may be required to cover a certain filter impulse duration when the tap delay is reduced, in particular in systems with over-sampling. In contrast, a long delay between the FIR filter taps, which refers to a low sampling rate, leads to a long filter impulse duration compared on the basis of the number of taps, which may compensate for a longer channel impulse response.

Analogously, the benefit of a short tap delay and a long filter impulse duration may be explained by the frequency domain representation of the FIR filter, also referred to the filter transfer function. The sampling rate defines the digital bandwidth, with a large sampling rate leading to a large digital bandwidth. The number of FIR taps refers to the number of frequency domain representatives of the transfer function within the digital bandwidth.

A short tap delay may refer to a large sampling rate with a wide digital bandwidth, which may avoid overlapping of the upper and lower sideband of the transfer function, also referred to as aliasing. A long tap delay refers to a low sampling rate with a small digital bandwidth. If the sampling rate satisfies the first Nyquist criterion, there is no aliasing. Given the same number of FIR taps, the transfer function for a shorter tap delay has a coarser frequency resolution with a less accurate representation of the transfer function. On the other hand, the transfer function for a longer tap delay has a finer frequency resolution with a more accurate representation of the transfer function. In optical transmission systems, a sampling rate of one sample per symbol (T=Tₛ) typically does not satisfy the Nyquist criterion. Preferable, a sampling rate of two samples per symbol is applied (T=Tₛ/2).

Further, according to some implementations, a low back to back penalty may be provided with a high resolution.

Moreover, according to some implementations, the robustness to all residual distortions prior to a time-domain filter stage at a given implementation complexity, i.e. at a total number of taps, may be increased. Further, the required number of taps may be reduced to reach a certain tolerance against linear channel distortions.

According to a first aspect, a filter device for filtering an input signal is provided. The filter device has a plurality of taps having a respective filter coefficient, and a plurality of delay elements, wherein at least two delay elements have different delays.

The filter device may be a digital filter, in particular a Finite Impulse Response (FIR) filter. Alternatively, the filter device may be an Infinite Impulse Response (IIR) filter. Further, the input signal may be an electrical input signal, in particular after an optical transmission. Furthermore, the input signal may be an optical input signal.

An example of the filter of the present invention may be a filter with a structure, where the taps in the center of the filter structure differ by a delay or tap delay of T=Tₛ/2 and at either side of the filter, the edges, the taps may differ by an extended tap delay of 2 T=Tₛ. In an example of a filter having nine taps, the five center taps may have a delay of T and the two taps of each edge may differ by a delay of 2 T. The closer tap spacing at the center may provide a good equalization with a detailed representation of the filter function. The larger delay at the edges of the hybrid filter may increase the total impulse response time of the filter, and thus may allow equalization of channel conditions with large memory.

According to some implementations, an arbitrary delay or time shift by factors αᵢ with αᵢ₋₁<αᵢ<αᵢ₊₁,αεR, with αᵢ being a real number, may lead to

r(t)=w_{M}s(t−α_{M}T)+w_{M-1}s(1−α_{M-1}T)+ . . . +w₁s(t−α₁T)+w₀s(t−α₀T).

In particular, a digital system may be confined to the sampling rate at the analog-to-digital conversion (ADC) with a sampling rate of N/T_{S} which leads to a sample time T_{S}/N. The tap delay may be whole-number multiple βᵢ,βᵢεZ, with βᵢ being a positive or a negative natural number, of the delay T=T_{S}/N. The filtered output signal r(t) may be described as:

r(t)=w_{M}s(t−β_{M}T)+w_{M-1}s(1−β_{M-1}T)+ . . . +w₁s(t−β₁T)+w₀s(t−β₀T)

Particularly, βᵢ maybe chosen to be β=[9,7,6,5,4,3,2,0], which may lead to a wider spacing at both edges of the filter and a narrow spacing at the center of the filter.

According to an implementation form, the respective delay element may be arranged between two taps.

According to an implementation form, each tap may have one filter coefficient and one delay element.

According to an implementation form, the filter device may comprise adjusting means for adjusting the delays of the delay elements of the filter device. Advantageously, by means of the adjusting means, the filter device may be adjustable and therefore adaptive.

According to an implementation form, said adjusting means may adjust the delay of the respective delay element in dependence on a position of the respective delay element in the filter device.

According to an implementation form, the plurality of delay elements may be connected in a series connection. Said series connection may have a number of center delay elements arranged in a center of the series connection and a respective number of edge delay elements arranged on edges of the series connection. The respective delay of the center delay elements may be smaller than the respective delay of the edge delay elements. In particular, said adjusting means may adjust a delay between center taps smaller than a delay between edged taps of the filter device.

According to an implementation form, all delay elements may be connected in a series connection. Said series connection may have a number of center delay elements arranged in a center of the series connection and a respective number of edge delay elements arranged on edges of the series connection. The respective delay of the center delay elements is the half of the respective delay of the edge delay elements.

According to an implementation form, said adjusting means may be configured to adjust the delays of the delay elements of the filter device, in particular to adjust the respective delay to be a multiple of a quotient between symbol duration of the input signal and an oversampling rate used for sampling the input signal.

According to an implementation form, the delay elements of the filter device may have several different delays. Thus, also more complex filter functions may be provided by the filter device of the present invention.

According to an implementation form, the filter device may have setting means for setting a delay between two adjacent taps by including or excluding one or more delay elements between the two adjacent taps.

The respective means, in particular the adjusting means and the setting means may be implemented in hardware or in software. If said means are implemented in hardware, it may be embodied as a device, e.g. as a computer or as a processor, or as a part of a system, e.g. a computer system. If said means are implemented in software, it may be embodied as a computer program product, as a function, as a routine, as a program code or as an executable object.

According to an implementation form, the respective delay of two adjacent taps may be static.

According to a second aspect, a filter arrangement is provided, wherein said filter arrangement has a plurality of above described filter devices.

According to a third aspect, a method for providing a filter device for filtering an input signal is suggested, the method comprising a step of providing a plurality of taps with a respective filter coefficient, and a step of providing a plurality of delay elements, wherein at least two delay elements have different delays.

According to a fourth aspect, the invention relates to a computer program comprising a program code for executing the method for providing a filter device when run in a computer.

According to a fifth aspect, a method for adjusting a filter device for filtering an input signal is provided, wherein said filter device has a plurality of taps having a respective filter coefficient and a series connection of a plurality of delay elements, the method comprising a step of providing the delay elements with adjustable delays, and a step of adjusting the delays starting to extend the delays of outer delay elements of the series connection first such that a filter memory of the filter device is increased.

According to sixth aspect, the invention relates to a computer program comprising a program code for executing the method for adjusting a filter device when run in a computer.

According to seventh aspect, a device for adjusting a filter device for filtering an input signal is suggested, said filter device having a plurality of taps respectively having a filter coefficient and a series connection of a plurality of delay elements, wherein the device has adjusting means for adjusting the delays of the delay elements starting with the outer delay elements of the series connection to increase a filter memory of the filter device.

### BRIEF DESCRIPTION OF THE DRAWINGS

Further embodiments of the invention will be described with respect to the following figures, in which:

FIG. 1 shows a filter device with constant delays;

FIG. 2 shows an embodiment of a filter device with different delays;

FIG. 3 shows a diagram illustrating a dependence of a required optical signal-to-noise-ratio to reach a bit-error-rate of 10⁻³ versus an optical channel impairment differential group delay for three different filter lengths;

FIG. 4 shows a diagram illustrating a filter impulse response for a differential group delay value of 0;

FIG. 5 shows a diagram illustrating a filter impulse response for a differential group delay value of 36 ps;

FIG. 6 shows a diagram illustrating a filter impulse response for a differential group delay value of 72 ps;

FIG. 7 shows a diagram illustrating an improvement for differential group delay tolerance;

FIG. 8 shows a diagram illustrating an improvement for chromatic dispersion tolerance;

FIG. 9 shows an embodiment of a method for providing a filter device, and

FIG. 10 shows an embodiment of a method for adjusting a filter device.

### DETAILED DESCRIPTION

FIG. 2 shows an embodiment of a filter device 200 with different delays T, 2 T.

The filter device 200 may be an FIR filter. The FIR filter 200 of FIG. 2 receives an input signal s(t) and outputs a filtered output signal r(t). The FIR filter 200 has seven taps 210-216. The respective tap 210-216 has a respective filter coefficient w₀-w₆. For example, the tap 211 has the filter coefficient w₁. Further, the FIR filter 200 has six delay elements 221-226. The delay elements 221-226 are arranged between two taps 210-216, respectively. The number of taps 210-216 and the number of delay elements 221-226 is only exemplarily in FIG. 2.

The center delay elements 222 to 225 of FIG. 2 have a tap delay of T. In contrast, the edge delay elements 221 and 226 have a delay of 2 T. Also, this structure is only exemplarily. By way of example, also the delay elements 222 and 225 may have a delay of 2 T.

The output of the taps 210-216 is added by an adder entity 230 to provide the output signal r(t).

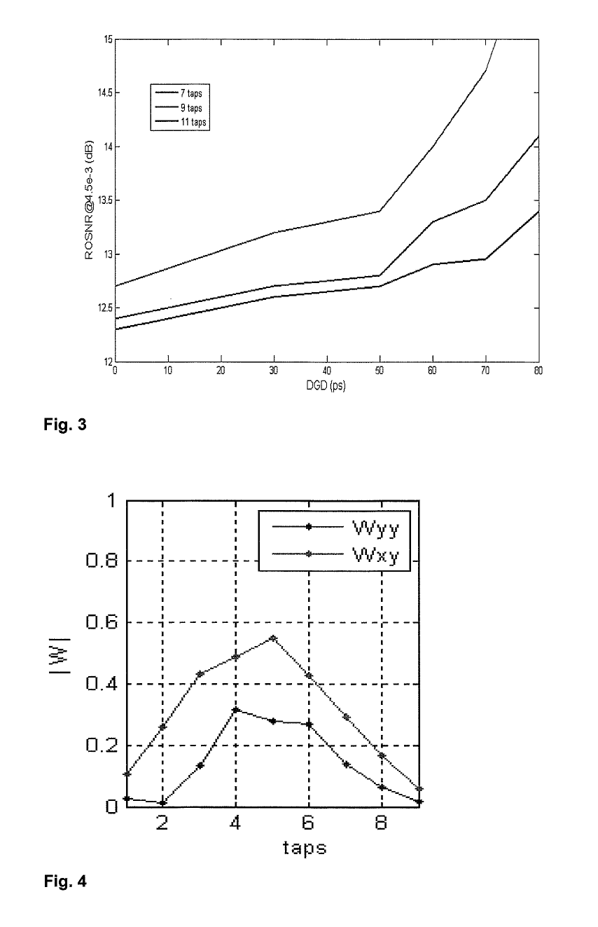

Referring to FIGS. 3 to 6, the optical channel impairment differential group delay (DGD) may introduce linear distortions, which may increase the channel memory. The length of the filter impulse response may be adapted to be longer or equal the length of the channel impulse response to allow penalty-free compensation of the channel impairments. Otherwise, the Bit Error Rate (BER) may be degraded or a higher Signal-to-Noise-Ratio (SNR) may be required to keep the BER constant.

In this regard, FIG. 3 shows a diagram illustrating a dependence of a Required Optical Signal-to-Noise-Ratio (OSNR) on optical channel impairment Differential Group Delay (DGD). In particular, FIG. 3 shows the required Optical Signal-to-Noise-Ratio (OSNR) versus DGD with different tap lengths. A length of nine taps may be sufficient up to 50 ps of DGD. Further, eleven taps may extend DGD range up to 70 ps.

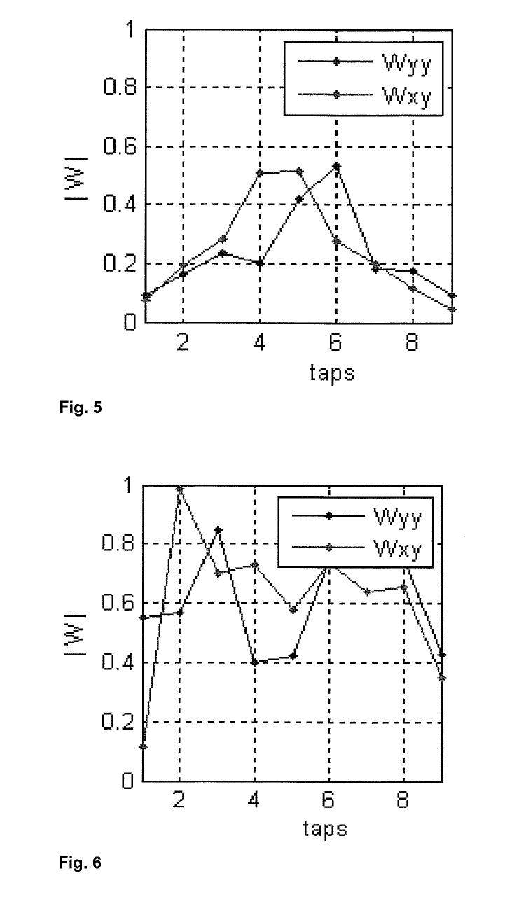

Furthermore, FIG. 4 shows a diagram illustrating a filter impulse response for a Differential Group Delay (DGD) value of 0. In an analogous way, FIGS. 5 and 6 show the same for 36 ps and 72 ps, respectively. With reference to FIG. 6, for 72 ps of DGD, the filter memory may be already to short. Taps to the edges may not decline to zero. In such a case, eleven taps would be required instead of nine taps to reach the required length of the filter impulse response.

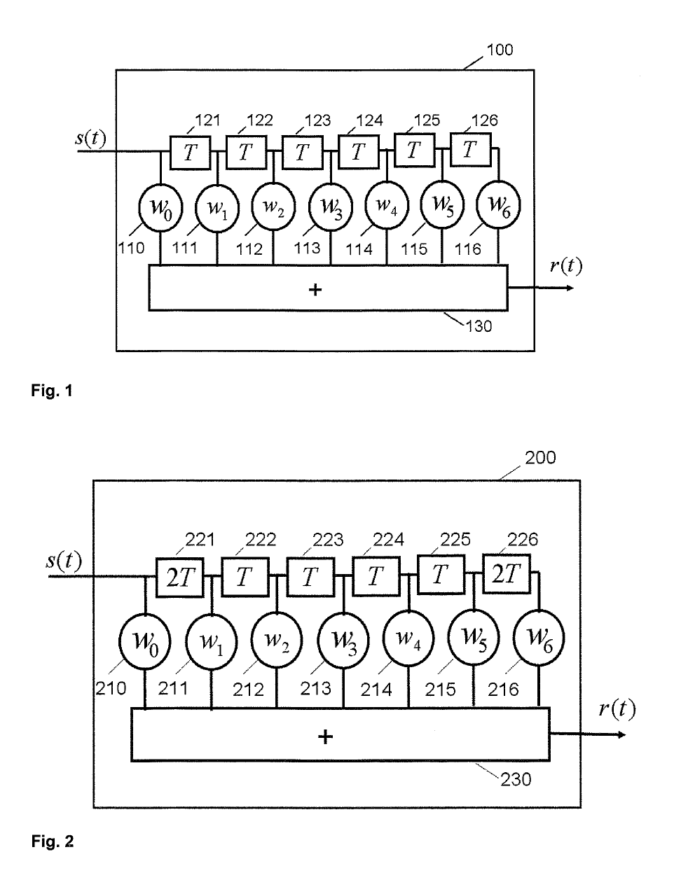

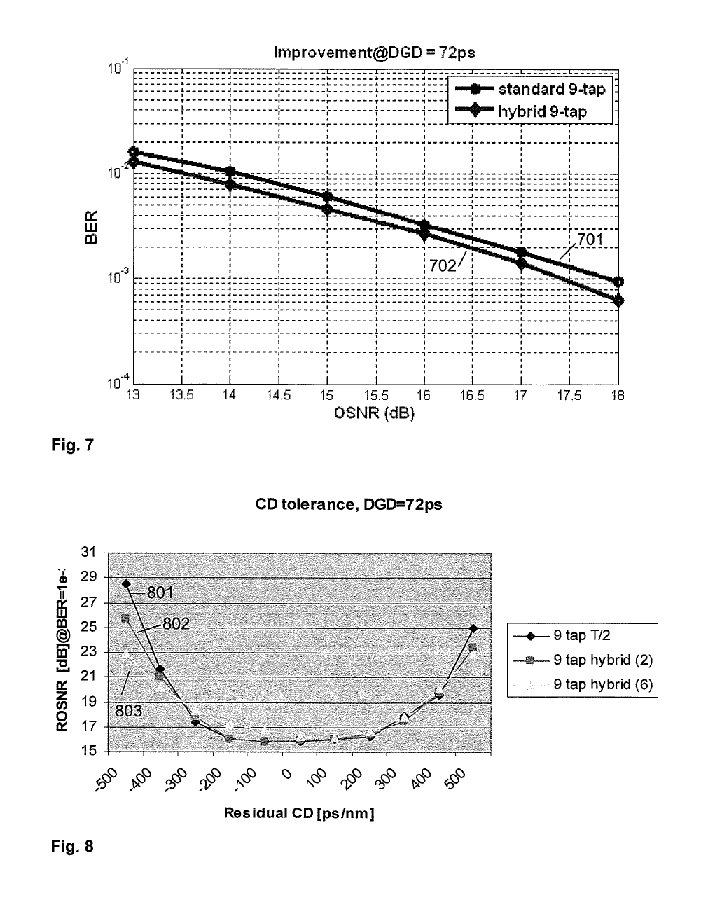

In FIG. 7, a diagram is depicted for illustrating an improvement for Differential Group Delay (DGD) tolerance. Particularly, curve 701 shows the case for a standard 9-tap filter FIR and, in contrast, curve 702 shows the case for a hybrid 9-tap FIR filter according to the present invention. Because curve 701 is clearly over curve 702, the improvement of the hybrid delay structure according to the present invention compared to a standard FIR structure with constant tap delay is clearly shown. The hybrid delay structure may apply a 2 T delay at the edges of the filter and T delay for the center taps, as shown in FIG. 2, for example. This may extend the filter impulse response length to 10 T compared to 8 T of a standard FIR structure, as exemplarily shown in FIG. 1.

FIG. 8 shows a diagram illustrating an improvement for chromatic dispersion (CD) tolerance. The x-axis of FIG. 8 shows the residual CD in ps/nm. Further, the y-axis shows the required OSNR (ROSNR). FIG. 8 shows three curves 801-803. The curve 801 is based on a filter structure with nine taps having a respective constant delay of T=Tₛ/2. The hybrid delay structures of curves 802 and 803 apply nine taps with a 2 T=Tₛ delay at the edges of the filter. In this regard, “hybrid (2)” of curve 802 applies an extended delay to one tap at each filter side, in sum two extended delays of 2 T. Further, “hybrid (6)” of curve 803 applies an extended delay to three taps at each filter side, in sum six extended delays of 2 T. Especially, for large values of CD, where the standard FIR structure according to curve 801 is already limited by its slow impulse length, the hybrid structure according to curves 802, 803 with its extended impulse length proves a clear benefit according to FIG. 8.

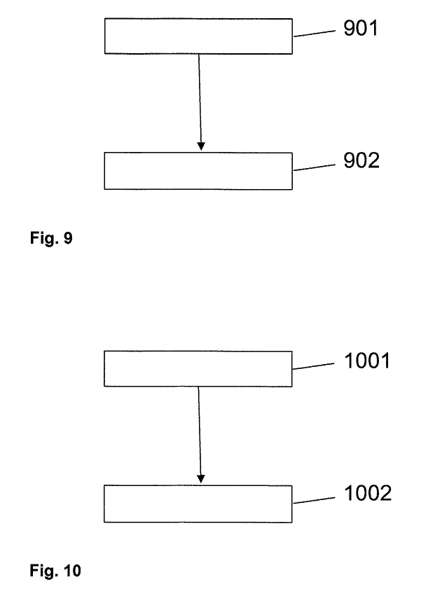

In FIG. 9, an embodiment of the method for providing a filter device is depicted.

As shown in FIG. 9, the method comprises a step of providing 901 a plurality of taps having a respective filter coefficient. Further, the method of FIG. 9 comprises a step of providing 902 a plurality of delay elements, wherein at least two delay elements have different delays.

Furthermore, in FIG. 10, an embodiment of the method for adjusting a filter device is depicted, said filter device having a plurality of taps having a respective filter coefficient and a series connection of a plurality of delay elements. An example of such a filter is shown in FIG. 2.

The method of FIG. 10 comprises a step of providing 1001 the delay elements with adjustable delays.

Furthermore, the method of FIG. 10 has a step of adjusting 1002 the delays starting to extend the delays of outer delay elements of the series connection first such that the filter memory of the filter device is increased.

According to some implementations, the filter device is embodied as a Finite impulse Response (FIR) filter. Further, the present invention may be also embodied as an Infinite Impulse Response (IIR) filter.

What is claimed is:

1. A filter device for filtering an input signal (s(t)), the filter device comprising:
a plurality of taps having a respective filter coefficient (w₀-w₆), and
a plurality of delay elements, wherein at least two delay elements have different delays.

2. The filter device of claim 1, wherein the respective delay element is arranged between two taps.

3. The filter device of claim 1, wherein a tap has at least one filter coefficient (w0-w6) and at least one delay element.

4. The filter device of claim 1, comprising adjusting means for adjusting the delays of the delay elements of the filter device.

5. The filter device of claim 1, comprising adjusting means for adjusting the delay of the respective delay element in dependence on a position of the respective delay element in the filter device or in a signal path.

6. The filter device of claim 1, wherein the delay elements are connected in series to form a series connection, said series connection having a number of center delay elements arranged in a center of the series connection and a respective number of edge delay elements arranged on edges of the series connection, wherein the respective delay of the center delay elements is smaller than the respective delay of the edge delay elements.

7. The filter device of claim 1, wherein the delay elements are connected in series to form a series connection, said series connection having a number of center delay elements arranged in a center of the series connection and a respective number of edge delay elements arranged on edges of the series connection, wherein the respective delay of the center delay elements is the half of the respective delay of at least one of the edge delay elements.

8. The filter device of claim 1, comprising adjusting means for adjusting the delays of the delay elements of the filter device, wherein the adjusting means are configured to adjust the respective delay to be a multiple of a quotient between a symbol duration of the input signal (s(t)) and an oversampling rate used for sampling the input signal (s(t)).

9. The filter device of claim 1, wherein the delay elements of the filter device have at least three different delays.

10. The filter device of claim 1, comprising setting means for setting a delay between two adjacent taps by including or excluding one or more delay elements between the two adjacent taps.

11. The filter device of claim 1, wherein the filter device is a Finite Impulse Response (FIR) filter.

12. A filter arrangement, comprising:
a plurality of filter devices of claim 1 for filtering the input signal (s(t)).

13. A method for providing a filter device for filtering an input signal (s(t)), the method comprising:
providing a plurality of taps having a respective filter coefficient (w₀-w₆); and
providing a plurality of delay elements, wherein at least two delay elements have different delays.

14. A method for adjusting a filter device for filtering an input signal (s(t)), said filter device having a plurality of taps respectively having a filter coefficient (w₀-w₆) and a series connection of a plurality of delay elements, the method comprising:
adjusting the delays of the delay elements starting with the outer delay elements of the series connection to increase a filter memory of the filter device.

15. A device for adjusting a filter device for filtering an input signal (s(t)), said filter device having a plurality of taps respectively having a filter coefficient (w₀-w₆) and a series connection of a plurality of delay elements, the device comprising:
adjusting means for adjusting the delays of the delay elements starting with the outer delay elements of the series connection to increase a filter memory of the filter device.
